(19) United States
(12) Patent Application Publication
(10) Pub. No.: US 2026/0369540 A1
(43) Pub. Date: Nov. 19, 2026

(54) Gas Efficiency for Solid Dopant-based Ion Sources

(71) Applicant: Applied Materials, Inc., Santa Clara, CA (US)

(72) Inventors: Graham Wright, Newburyport, MA (US); Ori Noked, Brookline, MA (US)

(21) Appl. No.: 19/209,563

(22) Filed: May 15, 2025

(51) Int. Cl. H01J 49/14; H01J 49/12

(52) U.S. Cl. CPC H01J 49/14; H01J 49/12; H01J 2237/334

(57) ABSTRACT

An ion source that includes an etching chamber with improved efficiency is disclosed. The improved efficiency may be realized by the use of a prechamber that transforms the etching gas into a more reactive species, containing radicals or ions. This more reactive gas may serve to etch more of the dopant-containing solid, creating more dopant-containing gas per mole of etching gas. The improved efficiency may also be achieved using a recycle conduit that returns some of the gas exiting the output of the etching chamber back to the input. Further, these two techniques may be used together. The improved efficiency results in a lower flow rate of unreacted etching gas to achieve a desired flow rate of dopant-containing gas in the ion source, which improves performance.

### FIELD

Embodiments of the present disclosure relate to an ion source and more particularly, an ion source having an etching chamber with improved gas efficiency.

### BACKGROUND

Various types of ion sources may be used to create the ions that are used in semiconductor processing equipment. For example, an indirectly heated cathode (IHC) ion source operates by supplying a current to a filament disposed behind a cathode. The filament emits thermionic electrons, which are accelerated toward and heat the cathode, in turn causing the cathode to emit electrons into the arc chamber of the ion source. The cathode is disposed at one end of an arc chamber. A repeller may be disposed on the end of the arc chamber opposite the cathode. The cathode and repeller may be biased so as to repel the electrons, directing them back toward the center of the arc chamber. In some embodiments, a magnetic field is used to further confine the electrons within the arc chamber. A plurality of sides is used to connect the two ends of the arc chamber.

An extraction aperture is disposed along one of these sides, proximate the center of the arc chamber, through which the ions created in the arc chamber may be extracted.

For some species, it is common to use a solid material that contains the desired dopant to provide the gas species used by the ion source. For example, an etching gas may be provided which contacts the dopant-containing solid, creating a gas that contains the dopant material. However, the flow rate of the dopant-containing gas may be relatively low, especially in comparison to the etching gas.

Therefore, it would be beneficial if there were a system that could be used to improve the conversion of the dopant-containing solid to dopant-containing gas within the etching chamber.

### SUMMARY

An ion source that includes an etching chamber with improved efficiency is disclosed. The improved efficiency may be realized by the use of a prechamber that transforms the etching gas into a more reactive species, containing radicals or ions. This more reactive gas may serve to etch more of the dopant-containing solid, creating more dopant-containing gas per mole of etching gas. The improved efficiency may also be achieved using a recycle conduit that returns some of the gas exiting the output of the etching chamber back to the input. Further, these two techniques may be used together. The improved efficiency results in a lower flow rate of unreacted etching gas to achieve a desired flow rate of dopant-containing gas in the ion source, which improves performance.

According to one embodiment, an ion source is disclosed. The ion source comprises an arc chamber configured to generate a plasma; a prechamber in communication with a first gas source, wherein the prechamber is adapted to increase a reactivity of a gas received from the first gas source so as to transform the gas from the first gas source into a reactive species; and an etching chamber, adapted to hold a dopant-containing solid material and in communication with the prechamber to receive the reactive species and supply a dopant-containing gas to the arc chamber via a conduit. In some embodiments, the gas from the first gas source comprises a neutral gas and the prechamber generates ions or radicals of the neutral gas. In certain embodiments, the prechamber comprises a plasma discharge chamber. In certain embodiments, the prechamber comprises an ionizer. In certain embodiments, the prechamber comprises a catalytic material chamber. In some embodiments, a heater is disposed proximate to the etching chamber to heat the dopant-containing solid material. In some embodiments, the gas from the first gas source comprises an etching species. In some embodiments, the etching species comprises a halogen. In some embodiments, the conduit passes a portion of an output from the etching chamber to the arc chamber and further comprises a recycle conduit to pass a remaining portion of the output from the etching chamber back to an input of the etching chamber. In some embodiments, a ratio of a cross-sectional area of the recycle conduit to the cross-sectional area of the conduit is defined as recycle ratio, and the recycle ratio is 0.5 or more. In some embodiments, an indirectly heated cathode is disposed in the arc chamber.

According to another embodiment, an ion source is disclosed. The ion source comprises an arc chamber configured to generate a plasma; and an etching chamber, adapted to hold a dopant-containing solid material, and in communication with a gas source, wherein the etching chamber comprises a conduit to pass a portion of an output from the etching chamber to the arc chamber and also comprises a recycle conduit to pass a remaining portion of the output from the etching chamber back to an input of the etching chamber. In some embodiments, a gas from the gas source comprises an etching species. In certain embodiments, the etching species comprises a halogen. In some embodiments, a heater is disposed proximate to the etching chamber to heat the dopant-containing solid material. In some embodiments, a ratio of a cross-sectional area of the recycle conduit to the cross-sectional area of the conduit is defined as recycle ratio, and the recycle ratio is 0.5 or more. In certain embodiments, the recycle ratio is 1 or more. In some embodiments, an indirectly heated cathode is disposed in the arc chamber.

According to another embodiment, an ion implanter is disclosed. The ion implanter comprises any of the ion sources described above, a mass analyzer and a workpiece holder.

### BRIEF DESCRIPTION OF THE FIGURES

For a better understanding of the present disclosure, reference is made to the accompanying drawings, which are incorporated herein by reference and in which:

FIG. 1 is an indirectly heated cathode (IHC) ion source in communication with an etching chamber containing a solid dopant material in accordance with one embodiment; and

FIG. 2 is an indirectly heated cathode (IHC) ion source in communication with an etching chamber containing a solid dopant material in accordance with a second embodiment;

FIG. 3 shows the improvement in fractionation that is achieved by recycling the output gas; and

FIG. 4 shows an ion implanter that uses the IHC ion source of FIG. 1 or FIG. 2.

### DETAILED DESCRIPTION

As noted above, certain dopants, such as aluminum and other metals, are initially in the form of solid dopant-containing materials, which are converted into dopant-containing gas through etching. Typically, a neutral etching gas, which may be a halogen, flows over a dopant-containing solid, which is usually heated. The neutral etching gas reacts with the dopant-containing solid to generate a dopant-containing gas. For example, fluorine may be flowed over aluminum to create aluminum trifluoride. However, if the reaction rate is poor, high flow rates of the neutral etching gas are used to generate sufficient dopant-containing gas for desired performance. In other words, the ratio of the flow rate of the dopant-containing gas to the flow rate of the neutral etching gas is low. This results in an excess of unreacted neutral etching gas, which enters the ion source and compromises the performance of the ion source. High pressure from unnecessary gas flow can lead to poor beam currents, poor beam stability, poor multi-charge fractionation, and even possible downstream contamination.

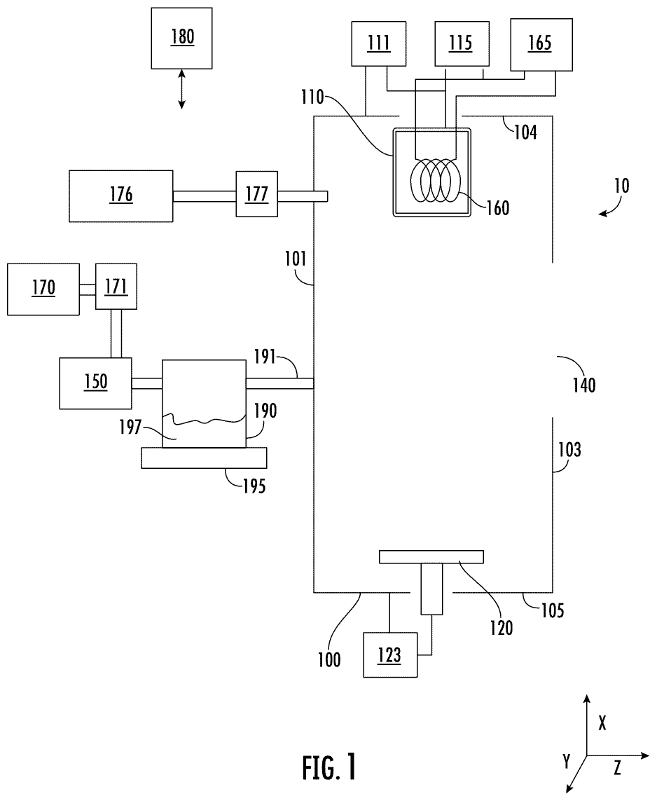

FIG. 1 shows an IHC ion source 10 that overcomes these issues. The IHC ion source 10 includes an arc chamber 100, comprising two opposite ends, and walls 101 connecting to these ends. The walls 101 of the arc chamber 100 may be constructed of an electrically conductive material and may be in electrical communication with one another. In some embodiments, a liner may be disposed proximate one or more of the walls 101. A cathode 110 is disposed in the arc chamber 100 at a first end 104 of the arc chamber 100. A filament 160 is disposed behind the cathode 110. The filament 160 is in communication with a filament power supply 165. The filament power supply 165 is configured to pass a current through the filament 160, such that the filament 160 emits thermionic electrons. Cathode bias power supply 115 biases filament 160 negatively relative to the cathode 110, so these thermionic electrons are accelerated from the filament 160 toward the cathode 110 and heat the cathode 110 when they strike the back surface of cathode 110. The cathode bias power supply 115 may bias the filament 160 so that it has a voltage that is between, for example, 200V to 1500V more negative than the voltage of the cathode 110. The cathode 110 then emits thermionic electrons on its front surface into arc chamber 100.

Thus, the filament power supply 165 supplies a current to the filament 160. The cathode bias power supply 115 biases the filament 160 so that it is more negative than the cathode 110, so that electrons are attracted toward the cathode 110 from the filament 160. In certain embodiments, the cathode 110 may be biased relative to the arc chamber 100, such as by bias power supply 111. In other embodiments, the cathode 110 may be electrically connected to the arc chamber 100, so as to be at the same voltage as the walls 101 of the arc chamber 100. In these embodiments, bias power supply 111 may not be employed and the cathode 110 may be electrically connected to the walls 101 of the arc chamber 100. In certain embodiments, the arc chamber 100 is connected to electrical ground.

On the second end 105, which is opposite the first end 104, a repeller 120 may be disposed. The repeller 120 may be biased relative to the arc chamber 100 by means of a repeller bias power supply 123. In other embodiments, the repeller 120 may be electrically connected to the arc chamber 100, so as to be at the same voltage as the walls 101 of the arc chamber 100. In these embodiments, repeller bias power supply 123 may not be employed and the repeller 120 may be electrically connected to the walls 101 of the arc chamber 100. In still other embodiments, a repeller 120 is not employed.

The cathode 110 and the repeller 120 are each made of an electrically conductive material, such as a metal or graphite.

In certain embodiments, a magnetic field is generated in the arc chamber 100. This magnetic field is intended to confine the electrons along one direction. The magnetic field typically runs parallel to the walls 101 from the first end 104 to the second end 105. For example, electrons may be confined in a column that is parallel to the direction from the cathode 110 to the repeller 120 (i.e. the x direction). Thus, electrons do not experience any electromagnetic force to move in the x direction. However, movement of the electrons in other directions may experience an electromagnetic force.

Disposed on one side of the arc chamber 100, referred to as the extraction plate 103, may be an extraction aperture 140. In FIG. 1, the extraction aperture 140 is disposed on a side that is parallel to the X-Y plane (perpendicular to the page).

An etching chamber 190 may be in communication with the arc chamber 100. For example, the etching chamber 190 may be disposed outside the arc chamber 100, and may include a conduit 191 connecting the output of the etching chamber 190 with the arc chamber 100. A heater 195 may be disposed proximate the etching chamber 190 to heat the dopant material 197 disposed within the etching chamber 190. The heater 195 may be a resistive heater or another type. The design of the heater is implementation specific and not limited by this disclosure. In certain embodiments, the dopant material 197 within the etching chamber 190 may be a solid compound that contains a metal. In other embodiments, the dopant material 197 may be a pure metal, wherein “pure” denotes that more than 90% of the material comprises the metal. For example, the dopant material 197 may be aluminum, germanium, lanthanum, indium, gallium or another metal. A prechamber 150 is in communication with the etching chamber 190. A first gas source 170 is in communication with the prechamber 150. The first gas source 170 may contain an etching gas, such as a halogen or hydrogen. A first valve 171 may be utilized to control the flow of the etching gas from the first gas source 170 to the prechamber 150. The prechamber 150 is used to increase the reactivity of the etching gas so as to transform the etching gas into a more reactive species, which may contain ions or radicals. As an example, if the etching gas is F₂, the etching gas may be transformed into F⁺ ions or F⁺ radicals, which are more reactive than molecular fluorine. The prechamber 150 may be a plasma discharge chamber, an ionizer, or a catalytic material chamber. A discharge plasma chamber typically comprises a radio frequency (RF) source which partially ionizes the gas, creating ions and radicals which are more reactive than the gas. In some embodiments, the plasma chamber may be in a capacitively coupled plasma configuration. In the case of a catalytic material chamber, the catalytic material may break the molecules of the etching gas, which are more reactive than the molecular etching gas, and also facilitate recombination of more potent reactive gases, especially if more than one gas is used. The reactive gas that exits from the prechamber 150 then enters the etching chamber 190. The reactive gas reacts more readily with the dopant material 197, producing more dopant-containing gas, relative to the etching gas, that is then delivered to the IHC ion source 10.

Note that in some embodiments, more than one gas may be used. For example, a halogen, such as fluorine, may be used in conjunction with hydrogen. This combination may produce HF, which enters the etching chamber 190.

Further, the IHC ion source 10 may optionally be in communication with a second gas source 176. The second gas source 176 may contain a second gas, which may be an inert gas, such as argon. A second valve 177 may be utilized to control the flow of the second gas from the second gas source 176 to the IHC ion source 10.

A controller 180 may be in communication with one or more of the power supplies such that the voltage or current supplied by these power supplies may be modified. The controller 180 may also be in communication with the first valve 171, the second valve 177, the prechamber 150 and the heater 195. The controller 180 may include a processing unit, such as a microcontroller, a personal computer, a special purpose controller, or another suitable processing unit. The controller 180 may also include a non-transitory storage element, such as a semiconductor memory, a magnetic memory, or another suitable memory. This non-transitory storage element may contain instructions and other data that allows the controller 180 to perform the functions described herein.

In operation, the filament power supply 165 passes a current through the filament 160, which causes the filament 160 to emit thermionic electrons. These electrons strike the back surface of the cathode 110, which may be more positive than the filament 160, causing the cathode 110 to heat, which in turn causes the cathode 110 to emit electrons into the arc chamber 100. These electrons collide with the molecules of gas that are fed into the arc chamber 100 through the conduit 191.

The controller 180 opens the first valve 171 so as to allow the flow of the etching gas into the prechamber 150. The etching gas may be a halogen. The controller 180 also controls the heater 195 so as to heat the dopant material 197 within the etching chamber 190 to a temperature such that the dopant material 197 more readily reacts with the reactive gas that exits from the prechamber 150. This produces a higher ratio of dopant-containing gas to etching gas than would otherwise be achieved. The dopant-containing gas enters the arc chamber 100 through the conduit 191. The combination of electrons from the cathode 110 and the dopant-containing gas creates a plasma. Ions from this plasma may then be extracted through the extraction aperture 140.

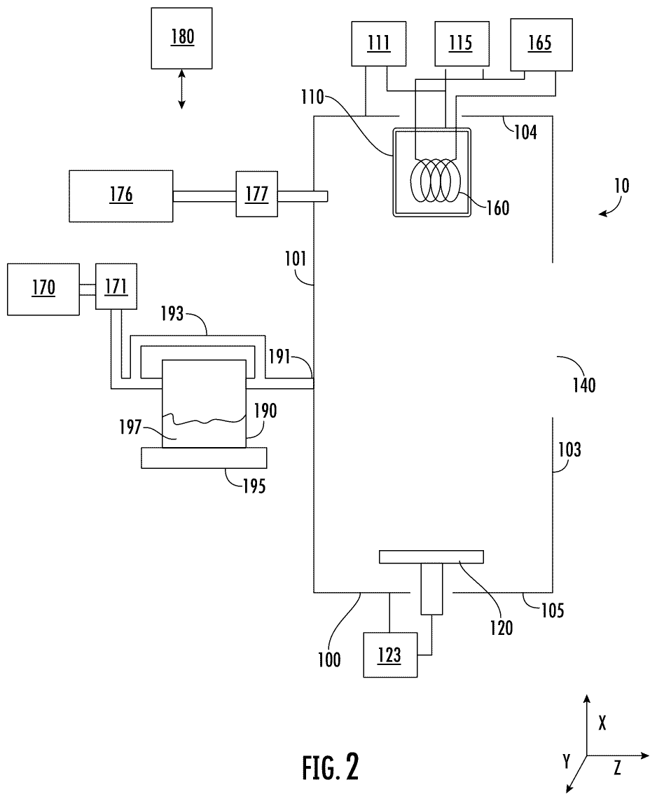

FIG. 2 shows a second embodiment of an IHC ion source 10 that overcomes these issues. Similar components have been given identical reference designators and are not described again. In this embodiment, the system includes a recycle conduit 193 that returns some of the gas that exits from the etching chamber 190 back to the input to the etching chamber 190. This increases the effective fractionation of the dopant-containing solid. Specifically, assume that the percentage of the etching gas that reacts with the dopant material 197, which is referred to herein as the nominal fractionation percentage, is F %. This implies that (1−F) % of the etching gas passes unchanged through the etching chamber 190. By returning some of the gas to the input of the etching chamber 190, the utilization of the etching gas may be increased. Using a plug flow model, it may be estimated that the effective fractionation may be defined as:

$$Effective Fractionation = 1 - \frac{1}{( 1 + R ) {e}^{x ( 1 + R )} - R}$$

In the above equation, R represents the ratio of the cross-sectional area of the recycle conduit 193 to the cross-sectional area of the conduit 191 that enters the arc chamber 100 of the IHC ion source 10, and is referred to herein as the recycle ratio. X represents the performance factor, which is related to the efficiency of the etching process. Note that, without any recycling (i.e. R=0), the effective fractionation, which is also referred to as the nominal fractionation, is given by:

$$Nominal Frationation = 1 - \frac{1}{{e}^{x}}$$

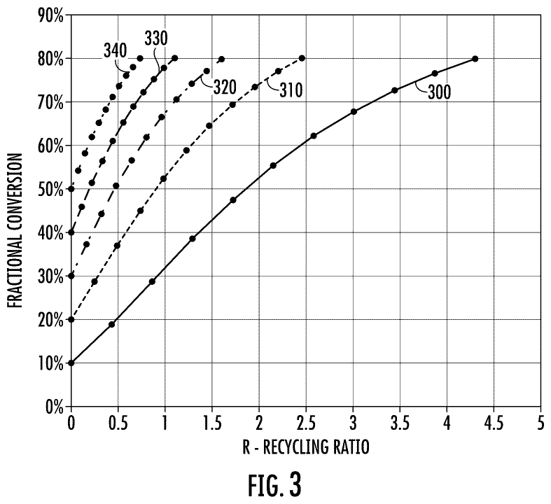

FIG. 3 shows a graph that shows the effect of recycling some of the gas from the output of the etching chamber 190 back to its input. The horizontal axis represents the recycle ratio, which is the ratio of the cross-sectional area of the recycle conduit 193 to the cross-sectional area of the conduit 191 that enters the arc chamber 100. The vertical axis represents the effective fractionation of the dopant-containing solid. The various lines represent various different nominal fractionation percentages, wherein lines 300, 310, 320, 330 and 340 represent nominal fractionations of 10%, 20%, 30%, 40% and 50%, respectively. As noted above, line 300 assumes a nominal fractionation of only 10%. However, if the recycle conduit 193 has a cross-sectional area that is the same as that of the conduit 191 that enters the arc chamber 100, (i.e. R=1) the effective fractionation may more than double. This may also be true for nominal fractionation values up to 30%. Further, FIG. 3 shows the recycle ratio needed to achieve an effective fractionation percentage of 80% for the various nominal fractionation percentages. Note that even with low nominal fractionation values, high efficiency may be achieved by proper sizing of the recycle conduit 193 and the conduit 191. Thus, in some embodiments, the recycle ratio is 1 or more. In other embodiments, the recycle ratio may be 2 or more. Note that at higher nominal fractionation values, efficiencies over 50% may be achieved with a recycle ratio of 0.5 or more.

Note that the embodiments of FIGS. 1 and 2 may be combined such that a prechamber 150 is used to transform the etching gas into a more reactive species and there is also a recycle conduit 193 to further increase the effective fractionation.

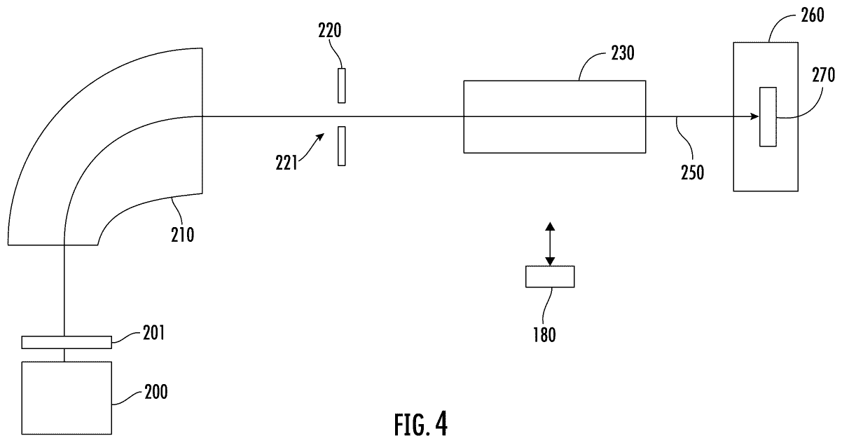

FIG. 4 shows a ion implanter that may be used with the IHC ion source of FIG. 1 or FIG. 2. The ion source 200 is used to generate an ion beam 250. In some embodiments, the ion source 200 may output a ribbon ion beam. In other embodiments, the ion source 200 may output a spot beam. The ion source 200 may be the ion source of FIG. 1 or FIG. 2. Disposed outside and proximate the extraction aperture of the ion source 200 is the extraction optics 201, which may comprise one or more electrodes.

Located downstream from the extraction optics 201 is a mass analyzer 210. The mass analyzer 210 uses magnetic fields to guide the path of the extracted ion beam. The magnetic fields affect the flight path of ions according to their mass and charge. A mass resolving device 220 that has a resolving aperture 221 is disposed at the output, or distal end, of the mass analyzer 210. By proper selection of the magnetic fields, only those ions in the ion beam 250 that have a selected mass and charge will be directed through the resolving aperture 221. Other ions will strike the mass resolving device 220 or a wall of the mass analyzer 210 and will not travel any further in the system.

One or more components 230 may be located downstream from the mass resolving device 220 and upstream from the process chamber 260. These components may include a collimator in the case where the ion source 200 outputs a ribbon ion beam, or an electrostatic scanner in the case where the ion source 200 outputs a spot beam. Additionally, these components 230 may include focusing lenses and an acceleration and/or deceleration stage to independently control deflection, deceleration, and focus of the ion beam 250.

The ion beam 250 that exits the one or more components 230 enters the process chamber 260, where the workpiece holder 270 is located.

The controller 180 may be in communication with the mass analyzer 210, and one or more of the power supplies to control the implant process.

Note that while an IHC ion source is disclosed, the prechamber 150 and/or recycle conduit 193 may be used with any type of ion source, such as those that utilize capacitively coupled plasma, inductively coupled plasma, Bernas sources, and others. Thus, any ion source that includes an arc chamber that is configured to generate a plasma may be used. The plasma may be generated using a filament, an indirectly heated cathode, an antenna, or another component.

The embodiments described above in the present application may have many advantages. In both embodiments, the efficiency of the etching process is improved such that more dopant-containing gas is produced per mole of etching gas. Note that if the reaction rate increases, less etching gas is needed to achieve the desired flow rate of the dopant-containing gas. This results in less unreacted etching gas in the ion source, which allows better control of the conditions within the ion source and makes it easier to obtain high performance.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings, such Thus, other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An ion source, comprising:
an arc chamber configured to generate a plasma;
a prechamber in communication with a first gas source, wherein the prechamber is adapted to increase a reactivity of a gas received from the first gas source so as to transform the gas from the first gas source into a reactive species; and
an etching chamber, adapted to hold a dopant-containing solid material and in communication with the prechamber to receive the reactive species and supply a dopant-containing gas to the arc chamber via a conduit.

2. The ion source of claim 1, wherein the gas from the first gas source comprises a neutral gas and the prechamber generates ions or radicals of the neutral gas.

3. The ion source of claim 2, wherein the prechamber comprises a plasma discharge chamber.

4. The ion source of claim 2, wherein the prechamber comprises an ionizer.

5. The ion source of claim 2, wherein the prechamber comprises a catalytic material chamber.

6. The ion source of claim 1, further comprising a heater proximate to the etching chamber to heat the dopant-containing solid material.

7. The ion source of claim 1, wherein the gas from the first gas source comprises an etching species.

8. The ion source of claim 7, wherein the etching species comprises a halogen.

9. The ion source of claim 1, wherein the conduit passes a portion of an output from the etching chamber to the arc chamber and further comprising a recycle conduit to pass a remaining portion of the output from the etching chamber back to an input of the etching chamber.

10. The ion source of claim 9, wherein a ratio of a cross-sectional area of the recycle conduit to the cross-sectional area of the conduit is defined as recycle ratio, and the recycle ratio is 0.5 or more.

11. The ion source of claim 1, further comprising an indirectly heated cathode disposed in the arc chamber.

12. An ion implanter, comprising:
the ion source of claim 1;
a mass analyzer; and
a workpiece holder.

13. An ion source, comprising:
an arc chamber configured to generate a plasma; and
an etching chamber, adapted to hold a dopant-containing solid material, and in communication with a gas source, wherein the etching chamber comprises a conduit to pass a portion of an output from the etching chamber to the arc chamber and also comprises a recycle conduit to pass a remaining portion of the output from the etching chamber back to an input of the etching chamber.

14. The ion source of claim 13, wherein a gas from the gas source comprises an etching species.

15. The ion source of claim 14, wherein the etching species comprises a halogen.

16. The ion source of claim 13, further comprising a heater proximate to the etching chamber to heat the dopant-containing solid material.

17. The ion source of claim 13, wherein a ratio of a cross-sectional area of the recycle conduit to the cross-sectional area of the conduit is defined as recycle ratio, and the recycle ratio is 0.5 or more.

18. The ion source of claim 17, wherein the recycle ratio is 1 or more.

19. The ion source of claim 13, further comprising an indirectly heated cathode disposed in the arc chamber.

20. An ion implanter, comprising:
the ion source of claim 13;
a mass analyzer; and
a workpiece holder.
